(19) United States
(12) Patent Application Publication
(10) Pub. No.: US 2026/0086032 A1
(43) Pub. Date: Mar. 26, 2026

(54) OPTICAL COHERENCE TOMOGRAPHY APPARATUS, OPTICAL COHERENCE TOMOGRAPHY METHOD, AND RECORDING MEDIUM

(71) Applicant: CASIO COMPUTER CO., LTD., Tokyo (JP)

(72) Inventors: Koichi OTSUKA, Tokyo (JP); Katsuyuki MATSUO, Tokyo (JP); Tasuku MUTO, Tokyo (JP); Takeshi MIYAZAKI, Tokyo (JP)

(73) Assignee: CASIO COMPUTER CO., LTD., Tokyo (JP)

(21) Appl. No.: 19/326,753

(22) Filed: Sep. 12, 2025

(30) Foreign Application Priority Data
Sep. 20, 2024 (JP) 2024-164648

(51) Int. Cl. G01N 21/47; G01N 21/17

(52) U.S. Cl. CPC G01N 21/4795; G01N 2021/1765

(57) ABSTRACT

An optical coherence tomography apparatus generates a tomographic image of measurement target based on an interference signal generated by synthesizing reflected light of measurement light reflected in the measurement target with reference light. The optical coherence tomography apparatus includes: a first mirror reflecting the reflected light of the measurement light reflected deep in the measurement target to a first direction for synthesis with the reference light and causing the measurement light to scan the measurement target by rotation with a first axis as an axis of rotation; and an image capturer capturing an image of a surface of the measurement target by using object light that is visible light emitted from the surface of the measurement target. The first mirror is fixed in an orientation for reflecting the object light to a direction of the image capturer in a case where the image capturer is in an image capture state.

### CROSS-REFERENCE TO RELATED APPLICATIONS

This application claims the benefit of Japanese Patent Application No. 2024-164648, filed on September 20, 2024, the entire disclosure of which is incorporated by reference herein.

### FIELD OF THE INVENTION

The present disclosure relates to an optical coherence tomography apparatus, an optical coherence tomography method, and a recording medium.

### BACKGROUND OF THE INVENTION

A photography apparatus using optical coherence tomography (OCT) is known as an apparatus that can photograph a tomographic image of a measurement target (for example, Unexamined Japanese Patent Application Publication No. 2018-171347). An optical coherence tomography apparatus described in Unexamined Japanese Patent Application Publication No. 2018-171347 repeatedly scans a measurement target irradiated with measurement light and generates a tomographic image based on an interference signal between reflected light deep in the measurement target and reference light, and outputs, based on inclination of the measurement target relative to the measurement light, a guide for guiding an operation of a probe gripped by an operator. It is described that this improves probe operability.

### SUMMARY OF THE INVENTION

A first aspect of an optical coherence tomography apparatus according to the present disclosure is an optical coherence tomography apparatus splitting light output from a light source into measurement light and reference light, irradiating a measurement target with the measurement light in a scanning manner, and generating a tomographic image based on an interference signal generated by synthesizing reflected light of the measurement light reflected in the measurement target with the reference light. The optical coherence tomography apparatus includes: a first mirror reflecting the reflected light of the measurement light reflected deep in the measurement target to a first direction for synthesis with the reference light and causing the measurement light to scan the measurement target by rotation with a first axis as an axis of rotation; and an image capturer capturing an image of a surface of the measurement target by using object light that is visible light emitted from the surface of the measurement target.

The first mirror is fixed in an orientation for reflecting the object light to a direction of the image capturer in a case where the image capturer is in an image capture state.

Further, an optical coherence tomography apparatus according to a second aspect of the present disclosure includes: a first mirror reflecting the reflected light of the measurement light reflected deep in the measurement target to a first direction for synthesis with the reference light and causing the measurement light to scan the measurement target by rotation with a first axis as an axis of rotation; an image capturer capturing an image of a surface of the measurement target by using object light that is visible light emitted from the surface of the measurement target; and an optical filter provided between the first mirror and the measurement target and reflecting light in a predetermined wavelength band including a wavelength of the object light to a direction of the image capturer.

### BRIEF DESCRIPTION OF DRAWINGS

A more complete understanding of this application can be obtained when the following detailed description is considered in conjunction with the following drawings, in which:

FIG. 1 is a schematic view illustrating an optical coherence tomography apparatus according to Embodiment 1 of the present disclosure;

FIG. 2 is a perspective view illustrating a scan probe according to Embodiment 1 during photography of a tomographic image;

FIG. 3 is a schematic view illustrating the scan probe according to Embodiment 1 during photography of a tomographic image;

FIG. 4 is a perspective view illustrating the scan probe according to Embodiment 1 during capture of an image of a surface;

FIG. 5 is a schematic view illustrating the scan probe according to Embodiment 1 during capture of an image of a surface;

FIG. 6 is a block diagram of the optical coherence tomography apparatus according to Embodiment 1;

FIG. 7 is a flowchart of optical coherence tomography processing according to Embodiment 1;

FIG. 8 is a perspective view illustrating a scan probe according to Embodiment 2;

FIG. 9 is a schematic view illustrating the scan probe according to Embodiment 2; and

FIG. 10 is a flowchart of optical coherence tomography processing according to Embodiment 2.

### DETAILED DESCRIPTION OF THE INVENTION

Hereinafter, embodiments of the present disclosure are described with reference to drawings. Note that, the same or equivalent parts in the drawings are denoted by the same reference signs.

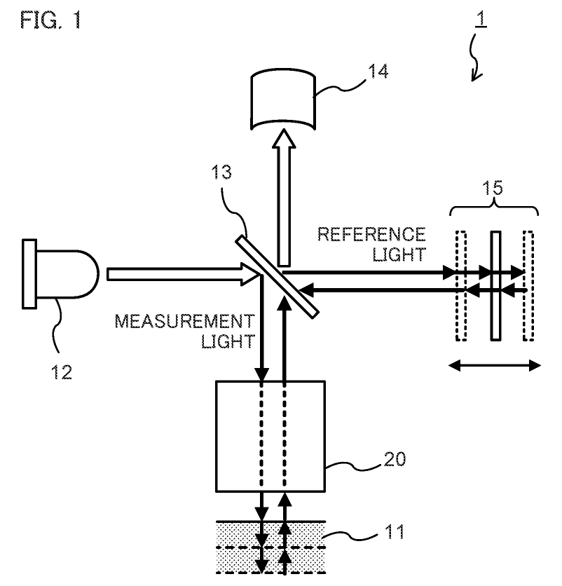

An optical coherence tomography apparatus 1 according to Embodiment 1 of the present disclosure is a photography apparatus that photographs a tomographic image of a measurement target 11, and is an apparatus that uses, for example, time-domain optical coherence tomography (OCT) as illustrated in FIG. 1. The measurement target 11 may be, for example, a human or animal eye, ear, internal organ or skin, a plant body, a painted body such as an automobile, a structure such as concrete, a precision part, or electronic equipment. As illustrated in FIG. 1, in the optical coherence tomography apparatus 1, light output from a light source 12 is split at a beam splitter 13 into measurement light and reference light, and the measurement target 11 is irradiated with the measurement light in a scanning manner. A photosensor 14 receives synthesized light of reflected light of the measurement light reflected deep in the measurement target 11 and the reference light reflected at a reference mirror 15, and outputs an interference signal between the reflected light and the reference light. Note that, FIG. 1 is schematic representation of optical components, optical paths, and the like, and, in reality, for example, a 2×2 optical coupler is used as the beam splitter 13 and all or a part of optical paths between the light source 12 and the beam splitter 13, between the beam splitter 13 and a scan probe 20, between the beam splitter 13 and the reference mirror 15, and between the beam splitter 13 and the photosensor 14 is configured by an optical fiber.

The light source 12 is a super luminescent diode (SLD) light source in a near-infrared region, for example, with wavelengths from 800 nm to 1600 nm, and a wavelength of light output by the light source 12 differs depending on a measurement target or a measurement condition. For example, in a case where the measurement target is a human eye, the wavelength is an 830 nm band, an 850 nm band, or a 1050 nm band. Further, in a case of OCT measurement of an endoscope or a catheter, light of 1310 nm or 1325 nm is used. The photosensor 14 is any photoelectric conversion element such as, for example, a photodiode. The reference mirror 15 is a mirror that reflects the reference light. By translating the reference mirror 15 with a not-illustrated driver to change a distance from the beam splitter 13, an interference distance with the reflected light in the measurement target 11 changes. A peak position of an interference signal output by the photosensor 14 at a time of changing the interference distance can be detected as an inter-layer boundary position of the measurement target 11. In other words, by moving the reference mirror 15, the measurement target 11 can be scanned in a depth direction. The scan in the depth direction is also called A-scan.

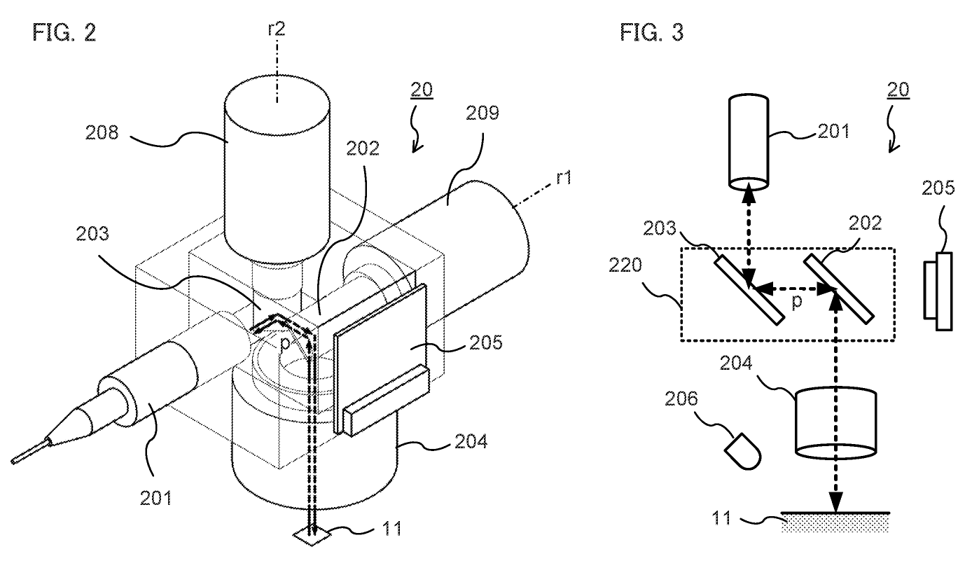

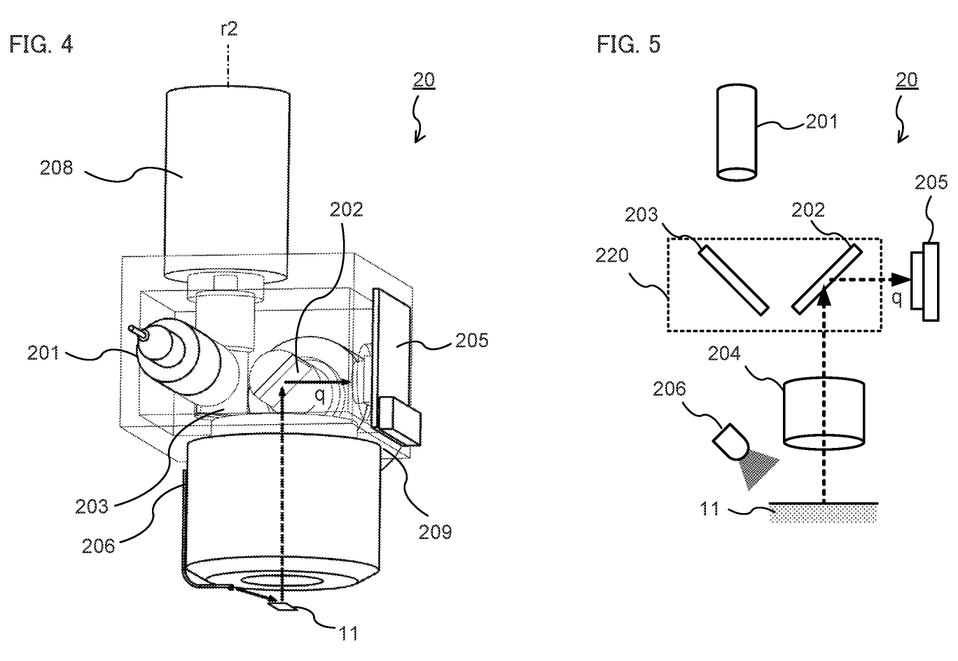

The scan probe 20 between the beam splitter 13 and the measurement target 11 scans with the measurement light in a direction orthogonal to the depth direction of the measurement target 11. A configuration of the scan probe 20 according to the present embodiment is described in detail by using FIGS. 2 to 5. FIGS. 2 and 4 are perspective views illustrating configurations of the scan probe 20 arranged in three-dimensional space. FIGS. 3 and 5 are views schematically representing configurations of the scan probe 20 illustrated in FIGS. 2 and 4, respectively, in order to describe functions of the configurations, and arrangement of the configurations and a light propagation direction are not necessarily limited thereto. As illustrated in FIGS. 2 to 5, the scan probe 20 includes a fiber collimator 201, a first mirror 202 and a second mirror 203 that are scan mirrors, an Fθ lens 204, and an image capturer 205. A portion of the scan probe 20 including the first mirror 202 and the second mirror 203 functions as a reflector 220 that reflects the reflected light of the measurement light reflected deep in the measurement target 11 to a first direction p, and reflects object light that is visible light emitted from a surface of the measurement target 11 to a second direction q that is different from the first direction p.

The fiber collimator 201 is an optical part for collimating the measurement light incident on the scan probe 20 from the beam splitter 13 through the optical fiber by a lens and emitting the collimated light into space. The collimated light emitted from the fiber collimator 201 has a diameter of, for example, 3 to 4 mm. The second mirror 203 is a mirror that reflects the collimated measurement light to a direction of the first mirror 202. Furthermore, the second mirror 203 includes a second axis r2 orthogonal to a light-incidence direction as an axis of rotation, and the second mirror 203 is rotated by a driver 208 with the second axis r2 as an axis of rotation. By the driver 208 rotating the second mirror 203, a reflection direction of the measurement light can be changed to scan the measurement target 11. For example, a reflective surface of the second mirror 203 is reciprocally rotated repeatedly in an angular width of 10 to 20 degrees with 45 degrees as a center angle relative to an optical axis of the fiber collimator 20, thereby changing a reflection direction of the measurement light. The scan by rotation of the second mirror 203 may be called B-scan.

The first mirror 202 is a mirror that reflects the measurement light reflected at the second mirror 203 to a direction of the measurement target 11. Furthermore, the first mirror 202 includes a first axis r1 orthogonal to a light-incidence direction as an axis of rotation, and the first mirror 202 is rotated by a driver 209 with the first axis r1 as an axis of rotation. By the driver 209 rotating the first mirror 202, a reflection direction of the measurement light can be changed to scan the measurement target 11. More specifically, a reflective surface of the first mirror 202 is reciprocally rotated repeatedly in an angular width of 10 to 20 degrees with 45 degrees as a center angle relative to an optical axis of the Fθ lens 204, thereby changing a reflection direction of the measurement light. The scan by rotation of the first mirror 202 may be called C-scan. As illustrated in FIG. 2, the second axis r2 that is the axis of rotation of the second mirror 203 has a mutually orthogonal relationship with a translated axis of the first axis r1 that is the axis of rotation of the first mirror 202. Thus, the B-scan by the second mirror 203 and the C-scan by the first mirror 202 are scans in mutually orthogonal directions.

Further, the first mirror 202 reflects, to a direction (first direction p) of the second mirror 203, the reflected light of the measurement light reflected deep in the measurement target 11 irradiated in a scanning manner. The reflected light is further reflected at the second mirror 203 to be incident on the fiber collimator 201. An interference signal between the reflected light passing through the fiber collimator 201 and the reference light is detected by the photosensor 14. That is, it can be said that an optical path of the reflected light from reflection deep in the measurement target 11 to synthesis with the reference light is identical to an optical path of the measurement light toward the measurement target 11. To be precise, scanning with the measurement light may cause a slight difference in the optical paths, but the optical paths are substantially identical. Further, the second mirror 203 is located on the optical path of the reflected light from reflection at the first mirror 202 to synthesis with the reference light. As illustrated in FIGS. 1 to 3, the optical coherence tomography apparatus 1 can obtain a three-dimensional shape of an inter-layer boundary of the measurement target 11, based on an interference signal between the reflected light of the measurement light reflected deep in the measurement target 11 and the reference light at a time of performing the B-scan and the C-scan in a plane direction orthogonal to a depth direction while performing the A-scan in the depth direction by translation of the reference mirror 15.

As illustrated in FIGS. 4 and 5, the first mirror 202 can be further rotated to orient the reflective surface toward the image capturer 205. More specifically, in a case where the image capturer 205 is in an image capture state, a direction of the reflective surface of the first mirror 202 is fixed in such a way that object light that is visible light emitted from the surface of the measurement target 11 is reflected at the first mirror 202 to the second direction q and incident on the image capturer 205. For example, the reflective surface of the first mirror 202 is oriented in a direction inclined at 45 degrees relative to an optical axis of the reflected light of the measurement light and a center line of the image capturer 205. An angle of rotation of the first mirror 20 from a state of scanning with the measurement light illustrated in FIG. 2 to a state of making the object light incident on the image capturer 205 illustrated in FIG. 4 is, for example, 90 degrees. In other words, 180-degree direction change from the first direction p from the first mirror 202 to the second mirror 203 illustrated in FIG. 2 to the second direction q from the first mirror 202 toward the image capturer 205 illustrated in FIG. 4 is achieved by 90-degree rotation of the first mirror 202. Note that, in the present embodiment, the angle of rotation of the first mirror 202 is 90 degrees since the image capturer 205 is arranged on the same optical axis as the measurement light incident on the first mirror 202. However, the angle of rotation of the first mirror 202 is not limited to 90 degrees depending on a position of arrangement of the image capturer 205. In this case, the first mirror 202 is rotatable further up to an angle necessary to switch the optical path to the image capturer 205 while ensuring an angular range (angular width of 10 to 20 degrees with 45 degrees as a center relative to the optical axis of the Fθ lens 204) for the C-scan.

The Fθ lens 204 is a lens that concentrates light of an area to be scanned by the B-scan and the C-scan into light having a predetermined spot diameter or less. The image capturer 205 captures an image of the surface of the measurement target 11 by using the object light incident thereon that is visible light emitted from the surface of the measurement target 11 and reflected at the first mirror 202, and is, for example, a camera. An irradiator 206 is a light source that irradiates the measurement target 11 with visible light in a case where the image capturer 205 captures an image of the surface of the measurement target 11, as illustrated in FIGS. 4 and 5. The irradiator 206 emits visible light having a wavelength of, for example, 300 to 700 nm. Note that, the image capturer 205 may capture an image by using the object light under a natural light environment. The surface of the measurement target 11 needs to be a material that reflects light of the irradiator 206 or natural light.

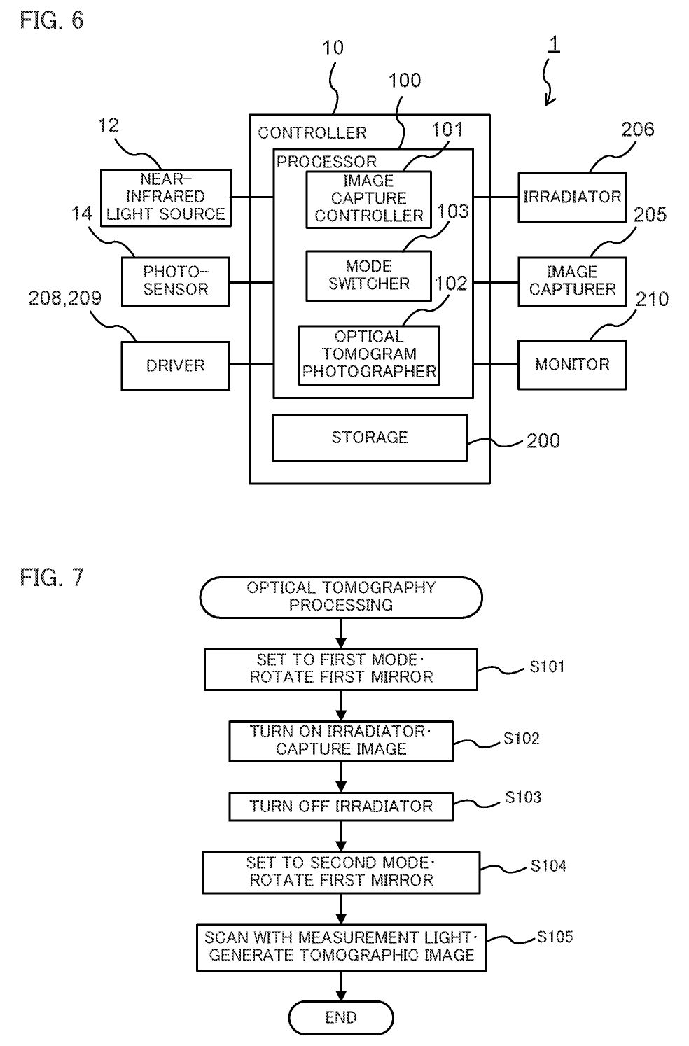

The optical coherence tomography apparatus 1 further includes a controller 10 that controls the above-described components and a monitor 210 that displays a tomographic image of the measurement target 11 and an image of the surface. As illustrated in FIG. 6, the controller 10 includes a processor 100 and a storage 200. The processor 100 is configured by, for example, a CPU, and executes various kinds of processing by using a program stored in the storage 200. The storage 200 includes, for example, a RAM and a non-volatile memory such as a ROM or a flash memory. The RAM functions as a working memory of the processor 100, and temporarily stores a program read from the non-volatile memory and data created or modified during execution of the program. The non-volatile memory stores a program executed by the CPU of the processor 100 and data necessary in advance for executing the program. Note that, the controller 10 according to the above embodiment includes the processor 100 and the storage 200, but the present disclosure is not limited thereto. For example, the controller 10 may be configured as a system in which a plurality of processors works collaboratively. Further, the storage 200 can be also configured to function in cooperation with an external storage device such as a cloud storage.

The processor 100 functions as an image capture controller 101, an optical tomogram photographer 102, and a mode switcher 103 by executing a program for optical coherence tomography processing stored in the storage 200. The image capture controller 101 rotates the first mirror 202 by driving of the driver 209, and orients the reflective surface in a direction for reflecting the object light emitted from the surface of the measurement target 11 at the first mirror 202 to be incident on the image capturer 205, as illustrated in FIG. 4. Further, the image capture controller 101 turns on the irradiator 206 and displays an image captured by the image capturer 205 on the monitor 210. Herein, the driver 209 driving the first mirror 202 and the irradiator 206 may work coordinately. In other words, the irradiator 206 may be turned on in a case where the first mirror 202 is oriented to reflect the object light to a direction toward the image capturer 205, and the irradiator 206 may be turned off in a case where the first mirror 202 is oriented to reflect the reflected light to a direction for synthesis with the reference light.

The optical tomogram photographer 102 rotates the first mirror 202 by driving of the driver 209, and orients the reflective surface of the first mirror 202 in a direction for reflecting the reflected light of the measurement light reflected deep in the measurement target 11 at the first mirror 202 to be incident on the second mirror 203, as illustrated in FIG. 2. The optical tomogram photographer 102 causes the light source 12 to output the measurement light, and scans the measurement target 11 with the measurement light by reciprocally driving the drivers 208 and 209 and the driver of the reference mirror 15 repeatedly. The optical tomogram photographer 102 further acquires a detection signal at a time when the reflected light is reflected at the first mirror 202 and the second mirror 203 and incident on the photosensor 14 through the fiber collimator 201, and generates a tomographic image based on the detection signal. The generated tomographic image is displayed on the monitor 210.

The mode switcher 103 switches, by an operation of a user or automatically, between a first mode for displaying a captured image of the surface of the measurement target 11 on the monitor 210 and a second mode for displaying a tomographic image of the measurement target 11. In other words, the mode switcher 103 switches between the first mode for activating the image capture controller 101 and the second mode for activating the optical tomogram photographer 102.

An operation of the optical coherence tomography apparatus 1 described above is described according to a flowchart in FIG. 7. The optical coherence tomography processing is executed with the scan probe 20 arranged near a measurement position of the measurement target 11. First, the image capture controller 101 is activated by the mode switcher 103 switching to the first mode, and the first mirror 202 is rotated (Step S101). Specifically, the first mirror 202 is rotated by the image capture controller 101 driving the driver 209, and a direction of the reflective surface of the first mirror 202 is fixed in such a way that object light emitted from the surface of the measurement target 11 is reflected at the first mirror 202 in the second direction q and incident on the image capturer 205, as illustrated in FIG. 4. Thereafter, the image capture controller 101 turns on the irradiator 206 to irradiate the measurement target 11 with visible light, and brings the image capturer 205 into an image capture state of capturing an image of the surface of the measurement target 11 by using the object light that is visible light emitted from the surface of the measurement target 11 (Step S102). The image captured by the image capturer 205 is displayed on the monitor 210. A user adjusts, based on the image displayed on the monitor 210, a position of the scan probe 20 relative to the measurement target 11. At this time, any of the measurement target 11 and the scan probe 20 may be moved. The user determines, based on the image displayed on the monitor 210, a position for photographing a tomographic image, aligns the position with a center of the Fθ lens 204, and fixes the position of the scan probe 20 relative to the measurement target 11. Thereafter, the irradiator 206 is turned off (Step S103).

Next, the optical tomogram photographer 102 is activated by the mode switcher 103 switching to the second mode for performing OCT measurement, and the first mirror 202 is rotated (Step S104). Specifically, the first mirror 202 is rotated by the optical tomogram photographer 102 driving the driver 209, and a direction of the reflective surface of the first mirror 202 is set in such a way that reflected light of the measurement light reflected deep in the measurement target 11 is reflected at the first mirror 202 in the first direction p and incident on the second mirror 203, as illustrated in FIG. 2. The optical tomogram photographer 102 turns on the light source 12, reciprocally moves the reference mirror 15 by driving of the driver of the reference mirror 15 while irradiating the measurement target 11 with the measurement light, and also reciprocally rotates the first mirror 202 and the second mirror 203 repeatedly by driving of the drivers 209 and 208. Thereby, the optical tomogram photographer 102 scans the measurement target 11 with the measurement light. The optical tomogram photographer 102 acquires a detection signal at a time when the reflected light is reflected at the first mirror 202 and the second mirror 203 and incident on the photosensor 14, and generates a tomographic image based on the detection signal (Step S105). The optical tomogram photographer 102 displays the generated tomographic image on the monitor 210, and ends the processing. In this way, a tomographic image at a desired position can be photographed after positioning based on an image captured by the image capturer 205.

As described above, the optical coherence tomography apparatus 1 according to Embodiment 1 splits light output from the light source into measurement light and reference light, irradiates the measurement target 11 with the measurement light in a scanning manner, and generates a tomographic image based on an interference signal generated by synthesizing reflected light of the measurement light reflected in the measurement target 11 with the reference light. The scan probe 20 of the optical coherence tomography apparatus 1 includes the first mirror 202 reflecting the reflected light of the measurement light reflected deep in the measurement target 11 to the first direction for synthesis with the reference light and causing the measurement light to scan the measurement target 11 by rotation with the first axis r1 as an axis of rotation, and the image capturer 205 capturing an image of a surface of the measurement target 11 by using object light that is visible light emitted from the surface of the measurement target 11. The first mirror 202 of the scan probe 20 is fixed in an orientation for reflecting the object light to a direction of the image capturer 205 in a case where the image capturer 205 is in an image capture state.

In the optical coherence tomography apparatus described in Unexamined Japanese Patent Application Publication No. 2018-171347, a position of a probe needs to be manually adjusted according to a guide in order to photograph a desired position of a measurement target, and has a problem of difficulty in determining a measurement position for an inexperienced operator. Further, purpose of use is limited because of difficulty in displaying an accurate guide in a case where the measurement target has a complicated shape.

The optical coherence tomography apparatus 1 according to Embodiment 1 can determine a position for photographing a tomographic image by using a captured image of the surface of the measurement target 11 since the image capturer 205 captures the image of the surface of the measurement target 11 by using the object light reflected at the first mirror 202.

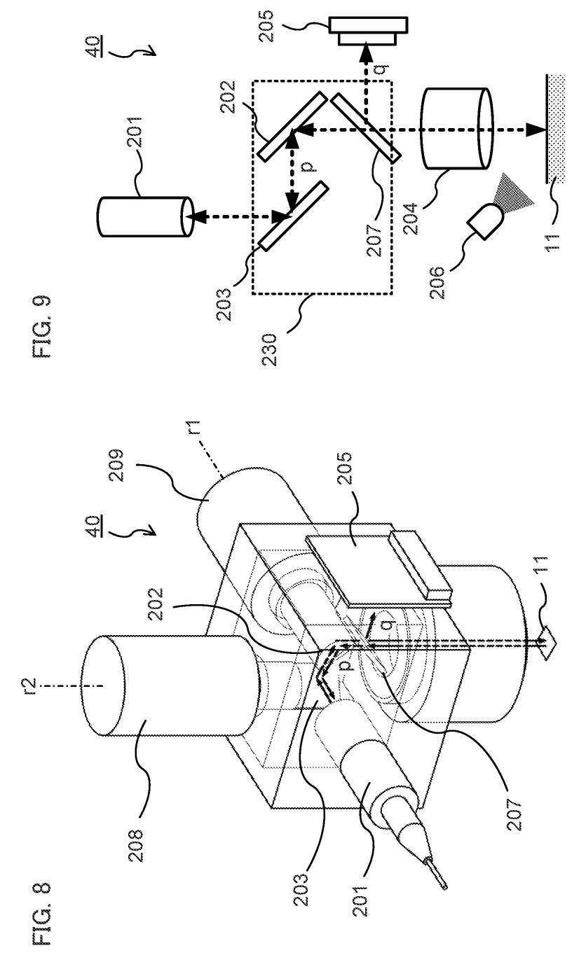

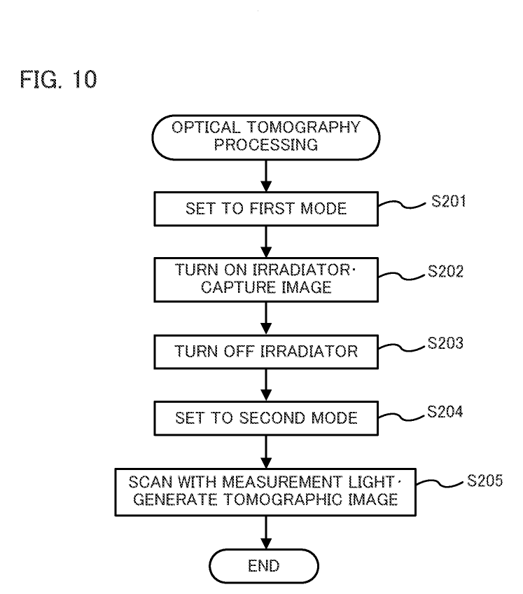

An optical coherence tomography apparatus 1 according to Embodiment 2 of the present disclosure is different from Embodiment 1 in a configuration of a reflector 230 of a scan probe 40. Other configurations are similar to Embodiment 1. A detailed description is given using FIGS. 8 and 9. The scan probe 40 of the optical coherence tomography apparatus 1 according to the present embodiment includes a fiber collimator 201, a first mirror 202 and a second mirror 203 that are scan mirrors, an Fθ lens 204, and an image capturer 205 that are similar to Embodiment 1. The scan probe 40 further includes an optical filter 207 provided between the first mirror 202 and the Fθ lens 204.

The optical filter 207 has a function of transmitting reflected light of measurement light reflected deep in a measurement target 11 toward the first mirror 202 and reflecting object light emitted from a surface of the measurement target 11 in a second direction q toward the image capturer 205. Specifically, the optical filter 207 is an optical filter that has a property of transmitting light in a wavelength band including near-infrared light output by a light source 12 and reflecting light in a predetermined range of wavelength bands including a wavelength of the object light. A portion of the scan probe 40 including the first mirror 202, the second mirror 203, and the optical filter 207 functions as the reflector 230 that reflects the reflected light of the measurement light reflected deep in the measurement target 11 to a first direction p, and reflects the object light emitted from the surface of the measurement target 11 to a second direction q that is different from the first direction p.

Configurations and functions of the fiber collimator 201 and the second mirror 203 are similar to Embodiment 1. The first mirror 202 is a mirror that reflects the measurement light reflected at the second mirror 203 in a direction of the measurement target 11 and reflects the reflected light of the measurement light reflected deep in the measurement target 11 in the first direction p toward the second mirror 203, similarly to Embodiment 1. The first mirror 202 includes a first axis r1 orthogonal to a light-incidence direction as an axis of rotation, and the first mirror 202 is rotated by a driver 209 with the first axis r1 as an axis of rotation. By the driver 209 rotating the first mirror 202, a reflection direction of the measurement light can be changed to scan the measurement target 11. More specifically, a reflective surface of the first mirror 202 is reciprocally rotated repeatedly in an angular width of 10 to 20 degrees with 45 degrees as a center angle relative to an optical axis of the Fθ lens 204 to change a reflection direction of the measurement light. In other words, the C-scan is performed by rotation of the first mirror 202. The first mirror 202 is only reciprocally rotated repeatedly in the above-described angular width of 10 to 20 degrees, and is different from Embodiment 1 in that the reflective surface is not oriented to a direction toward the image capturer 205. The present embodiment also can obtain a three-dimensional shape of an inter-layer boundary of the measurement target 11 by performing the B-scan and the C-scan in a plane direction orthogonal to a depth direction while performing the A-scan in the depth direction by translation of the reference mirror 15.

The optical filter 207 transmits the measurement light in a wavelength band of near-infrared light emitted by the light source 12 and the reflected light reflected by the measurement target 11 in a case of photographing a tomographic image by an optical tomogram photographer 102. The transmitted reflected light is reflected at the first mirror 202 and the second mirror 203 and incident on the photosensor 14. The optical filter 207 reflects visible light emitted from the surface of the measurement target 11 toward the image capturer 205 in a case of capturing an image of the surface of the measurement target 11 by an image capture controller 101. Thus, an image of the surface of the measurement target 11 can be captured without rotating the first mirror 202 by about 90 degrees.

An operation of the optical coherence tomography apparatus 1 described above is described according to a flowchart in FIG. 10. First, the image capture controller 101 is activated by a mode switcher 103 setting to the first mode (Step S201). Specifically, the image capture controller 101 turns on the irradiator 206 to irradiate the measurement target 11 with visible light, and the image capturer 205 captures an image of the surface of the measurement target 11 by using object light that is visible light emitted from the surface of the measurement target 11 (Step S202). The image captured by the image capturer 205 is displayed on a monitor 210. A user adjusts, based on the image displayed on the monitor 210, a position of the scan probe 20 relative to the measurement target 11. At this time, any of the measurement target 11 and the scan probe 40 may be moved. The user determines, based on the image displayed on the monitor 210, a position for photographing a tomographic image, aligns the position with a center of the Fθ lens 204, and fixes the position of the scan probe 40 relative to the measurement target 11. Thereafter, the irradiator 206 is turned off (Step S203).

Next, the optical tomogram photographer 102 is activated by the mode switcher 103 switching to the second mode, and the first mirror 202 is rotated (Step S204). Specifically, the optical tomogram photographer 102 turns on the light source 12, reciprocally moves the reference mirror 15 by driving of the driver of the reference mirror 15 while irradiating the measurement target 11 with the measurement light, and reciprocally rotates the first mirror 202 and the second mirror 203 repeatedly by driving of the drivers 209 and 208. Thereby, the optical tomogram photographer 102 scans the measurement target 11 with the measurement light. The optical tomogram photographer 102 acquires a detection signal at a time when the reflected light is reflected at the first mirror 202 and the second mirror 203 and incident on the photosensor 14, and generates a tomographic image based on the detection signal (Step S205). The optical tomogram photographer 102 displays the generated tomographic image on the monitor 210, and ends the processing. In this way, a tomographic image at a desired position can be photographed after positioning based on an image captured by the image capturer 205.

As described above, the optical coherence tomography apparatus 1 according to Embodiment 2 reflects object light toward the image capturer 205 by using the optical filter 207 provided between the first mirror 202 of the scan probe 40 and the measurement target 11 and reflecting light in a predetermined wavelength band including a wavelength of the object light. Thereby, a position for photographing a tomographic image can be determined by using a captured image of the surface of the measurement target 11 without widely rotating the first mirror 202.

While the embodiments of the present disclosure have been described above, the embodiments are examples, and an application range of the present disclosure is not limited thereto. In other words, the embodiments of the present disclosure can be applied in various ways, and any embodiments are included in the scope of the present disclosure. For example, in Embodiments 1 and 2, a case where the scan probes 20 and 40 are used for time-domain optical coherence tomography (OCT) has been described, but the present disclosure is not limited thereto. The scan probe 20 is used for any other optical coherence tomography apparatus such as a Fourier-domain optical coherence tomography.

Further, the first mirror 202 or the first mirror 202 and the optical filter 207 are used in Embodiment 1 or 2 as the reflector 220 or 230 reflecting the reflected light of the measurement light reflected deep in the measurement target 11 and object light emitted from the surface of the measurement target 11, but the configuration of the reflector 220 or 230 may be other configurations. For example, in a case where the reflected light of the measurement light reflected at the measurement target 11 has a spot diameter sufficiently smaller than a luminous flux of the object light, a third mirror including the rotatable first mirror 202 at a center and sufficiently larger than the first mirror 202 may be used for reflection of the object light.

Further, in above Embodiments 1 and 2, a program executed by the processor 100 is stored in advance in the non-volatile memory of the storage 200. However, the present disclosure is not limited thereto, and a program for executing the above optical coherence tomography processing may be implemented in an existing general-purpose computer or the like, thereby functioning as an apparatus equivalent to the controller 10 of the optical coherence tomography apparatus 1 according to above Embodiments 1 and 2.

Such a program may be provided by any way. For example, a program may be distributed in a way stored in a computer-readable recording medium (a flexible disk, a compact disc (CD)-ROM, a digital versatile disc (DVD)-ROM, a magneto optical (MO) disc, a memory card, a USB memory, or the like), or may be stored in a storage on a network such as the Internet and provided by downloading the same.

Further, when the above processing is executed by sharing between an operating system (OS) and an application program or by cooperation between an OS and an application program, only the application program may be stored in a recording medium or a storage. Further, a program can be superimposed on a carrier and delivered via a network. For example, the above program may be posted on a bulletin board system (BBS) on a network, and the program may be delivered via the network. Then, the program is started and executed under control of an OS in a way similar to other application programs, thereby enabling the above processing to be executed.

Further, the controller 10 may be configured as any processor alone such as a single processor, a multiprocessor, or a multi-core processor, or may be configured as a combination of any processor and a processing circuit such as an application specific integrated circuit (ASIC) or a field programmable gate array (FPGA).

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. An optical coherence tomography apparatus splitting light output from a light source into measurement light and reference light, irradiating a measurement target with the measurement light in a scanning manner, and generating a tomographic image based on an interference signal generated by synthesizing reflected light of the measurement light reflected in the measurement target with the reference light, the optical coherence tomography apparatus comprising:
a first mirror reflecting the reflected light of the measurement light reflected deep in the measurement target to a first direction for synthesis with the reference light and causing the measurement light to scan the measurement target by rotation with a first axis as an axis of rotation; and
an image capturer capturing an image of a surface of the measurement target by using object light that is visible light emitted from the surface of the measurement target,
wherein the first mirror is fixed in an orientation for reflecting the object light to a direction of the image capturer in a case where the image capturer is in an image capture state.

2. An optical coherence tomography apparatus splitting light output from a light source into measurement light and reference light, irradiating a measurement target with the measurement light in a scanning manner, and generating a tomographic image based on an interference signal generated by synthesizing reflected light of the measurement light reflected in the measurement target with the reference light, the optical coherence tomography apparatus comprising:
a first mirror reflecting the reflected light of the measurement light reflected deep in the measurement target to a first direction for synthesis with the reference light and causing the measurement light to scan the measurement target by rotation with a first axis as an axis of rotation;
an image capturer capturing an image of a surface of the measurement target by using object light that is visible light emitted from the surface of the measurement target; and
an optical filter provided between the first mirror and the measurement target and reflecting light in a predetermined wavelength band including a wavelength of the object light to a direction of the image capturer.

3. The optical coherence tomography apparatus according to claim 1, wherein an optical path of the reflected light from the measurement target to synthesis with the reference light is identical to an optical path of the measurement light toward the measurement target.

4. The optical coherence tomography apparatus according to claim 1, further comprising a second mirror on an optical path of the reflected light from reflection at the first mirror to synthesis with the reference light,
wherein the second mirror includes, as an axis of rotation, a second axis orthogonal to an axis parallel to the first axis that is an axis of rotation of the first mirror.

5. The optical coherence tomography apparatus according to claim 1, further comprising an irradiator irradiating the measurement target with visible light during capture of an image by the image capturer and turned off during generation of the tomographic image.

6. The optical coherence tomography apparatus according to claim 1, further comprising an irradiator irradiating the measurement target with visible light during capture of an image by the image capturer,
wherein the first mirror and the irradiator work coordinately, the irradiator is turned on in a case where the first mirror is oriented to reflect the object light to a direction of the image capturer, and the irradiator is turned off in a case where the first mirror is oriented to reflect the reflected light to a direction for synthesis with the reference light.

7. The optical coherence tomography apparatus according to claim 5, further comprising a controller selectably executing a first mode for displaying a tomographic image of the measurement target based on the interference signal between the reflected light and the reference light at a time of irradiating the measurement target with the measurement light in a scanning manner while the irradiator is turned off and a second mode for displaying an image of the surface of the measurement target captured by the image capturer with the object light while the irradiator is turned on.

8. An optical coherence tomography method splitting light output from a light source into measurement light and reference light, irradiating a measurement target with the measurement light in a scanning manner, and generating a tomographic image based on an interference signal generated by synthesizing reflected light of the measurement light reflected in the measurement target with the reference light, the optical coherence tomography method comprising:
fixing a first mirror rotated with a first axis as an axis of rotation in an orientation for reflecting object light that is visible light emitted from a surface of the measurement target to a direction of an image capturer and capturing, by the image capturer, an image of the surface of the measurement target; and
reflecting, by the first mirror, the reflected light of the measurement light reflected deep in the measurement target to a first direction for synthesis with the reference light, causing the measurement light to scan the measurement target by rotation of the first mirror, and generating the tomographic image based on an interference signal between the reflected light and the reference light.

9. An optical coherence tomography method splitting light output from a light source into measurement light and reference light, irradiating a measurement target with the measurement light in a scanning manner, and generating a tomographic image based on an interference signal generated by synthesizing reflected light of the measurement light reflected in the measurement target with the reference light, the optical coherence tomography method comprising:
reflecting, by an optical filter provided between a first mirror rotated with a first axis as an axis of rotation and the measurement target and reflecting light in a predetermined wavelength band including a wavelength of object light that is visible light emitted from a surface of the measurement target, the object light to a direction of an image capturer and capturing, by the image capturer, an image of the surface of the measurement target; and
transmitting the reflected light of the measurement light reflected deep in the measurement target through the optical filter and reflecting, by the first mirror, the reflected light to a first direction for synthesis with the reference light, causing the measurement light to scan the measurement target by rotation of the first mirror, and generating the tomographic image based on an interference signal between the reflected light and the reference light.

10. A non-transitory computer-readable recording medium storing a program, the program causing a computer controlling an optical coherence tomography apparatus splitting light output from a light source into measurement light and reference light, irradiating a measurement target with the measurement light in a scanning manner, and generating a tomographic image based on an interference signal generated by synthesizing reflected light of the measurement light reflected in the measurement target with the reference light to execute processing comprising:
fixing a first mirror rotatable with a first axis as an axis of rotation in an orientation for reflecting object light that is visible light emitted from a surface of the measurement target to a direction of an image capturer and displaying, on a monitor, an image of the surface of the measurement target captured by the image capturer; and
reflecting, by the first mirror, the reflected light of the measurement light reflected deep in the measurement target to a first direction for synthesis with the reference light, causing the measurement light to scan the measurement target by rotation of the first mirror, and displaying, on the monitor, a tomographic image generated based on an interference signal between the reflected light and the reference light.

11. A non-transitory computer-readable recording medium storing a program, the program causing a computer controlling an optical coherence tomography apparatus splitting light output from a light source into measurement light and reference light, irradiating a measurement target with the measurement light in a scanning manner, and generating a tomographic image based on an interference signal generated by synthesizing reflected light of the measurement light reflected in the measurement target with the reference light to execute processing comprising:
reflecting, by an optical filter provided between a first mirror rotated with a first axis as an axis of rotation and the measurement target and reflecting light in a predetermined wavelength band including a wavelength of object light that is visible light emitted from a surface of the measurement target, the object light to a direction of an image capturer and displaying, on a monitor, an image of the surface of the measurement target captured by the image capturer; and
transmitting the reflected light of the measurement light reflected deep in the measurement target through the optical filter and reflecting, by the first mirror, the reflected light to a first direction for synthesis with the reference light, causing the measurement light to scan the measurement target by rotation of the first mirror, and displaying, on the monitor, a tomographic image generated based on an interference signal between the reflected light and the reference light.

12. The optical coherence tomography apparatus according to claim 2, wherein an optical path of the reflected light from the measurement target to synthesis with the reference light is identical to an optical path of the measurement light toward the measurement target.

13. The optical coherence tomography apparatus according to claim 2, further comprising a second mirror on an optical path of the reflected light from reflection at the first mirror to synthesis with the reference light,
wherein the second mirror includes, as an axis of rotation, a second axis orthogonal to an axis parallel to the first axis that is an axis of rotation of the first mirror.

14. The optical coherence tomography apparatus according to claim 2, further comprising an irradiator irradiating the measurement target with visible light during capture of an image by the image capturer and turned off during generation of the tomographic image.
